(19) United States
(12) Patent Application Publication
(10) Pub. No.: US 2020/0044575 A1
(43) Pub. Date: Feb. 6, 2020

(54) SWITCHING POWER SUPPLY DEVICE

(71) Applicant: OMRON Corporation, Kyoto (JP)

(72) Inventors: Masaaki NAGANO, Kyoto-shi (JP); Kohei TANINO, Kyoto-shi (JP)

(73) Assignee: OMRON Corporation, Kyoto (JP)

(21) Appl. No.: 16/386,274

(22) Filed: Apr. 17, 2019

(30) Foreign Application Priority Data
Aug. 3, 2018 (JP) 2018-146677

(51) Int. Cl. H02M 3/335

(52) U.S. Cl. CPC H02M 3/33592

(57) ABSTRACT

An LLC type switching power supply device in which a burst operation hardly occurs at the time of a light load is provided. A switching power supply device includes an LLC resonant converter. The LLC resonant converter includes a transformer, a first capacitor connected to a primary winding of the transformer, a switching circuit which controls power transmission to the transformer and the first capacitor, a rectification circuit connected to a secondary winding of the transformer, a second capacitor connected to the rectification circuit, and an output terminal connected to the rectification circuit and the second capacitor. The switching power supply device further includes a stabilizing circuit which is connected to the output terminal and consumes power at the time of a light load of the LLC resonant converter.

### CROSS-REFERENCE TO RELATED APPLICATION

This application claims the priority benefit of Japan Application No. 2018-146677, filed on Aug. 3, 2018. The entirety of the above-mentioned patent application is hereby incorporated by reference herein and made a part of this specification.

### BACKGROUND

### Technical Field

The disclosure relates to a switching power supply device.

### Description of Related Art

At the time of a designed load, a switching power supply device operates as designed. However, at the time of a light load or no load, a different operation may be performed and thus some countermeasures may be required therefor. For example, Japanese Laid-open No. 2003-52174 (Patent Document 1) discloses a switching power supply device including a circuit for detecting a light load and a control circuit for intermittently operating switching elements in response to a light-load detection signal. For example, Japanese Laid-open No. H8-340675 (Patent Document 2) discloses a dummy load connected to the output of a switching power supply circuit at the time of a light load of the switching power supply circuit.

### PATENT DOCUMENTS

[Patent Document 1] Japanese Laid-open No. 2003-52174

[Patent Document 2] Japanese Laid-open No. H8-340675

Recently, an LLC type DC/DC converter (hereinafter referred to as an LLC resonant converter) has been widely used. In this LLC type, soft switching is realized using resonance according to two inductances L and one capacitance C.

In the case of LLC type, a switching frequency increases at the time of a light load due to characteristics of the LLC type. Accordingly, when a switching element is operated at a high switching frequency at the time of rated output of an LLC resonant converter, the switching frequency at the time of a light load further increases and thus a control circuit IC may not control the switching element. In such a case, the LLC resonant converter performs a burst operation.

The disclosure provides an LLC type switching power supply device in which it is difficult for a burst operation to occur at the time of a light load.

### SUMMARY

According to an embodiment, a switching power supply device includes an LLC resonant converter. The LLC resonant converter includes a transformer having a primary winding and a secondary winding, a first capacitor connected to the primary winding of the transformer, a switching circuit which controls power transmission to the transformer and the first capacitor, a rectification circuit connected to the secondary winding of the transformer, a second capacitor connected to the rectification circuit, and an output terminal connected to the rectification circuit and the second capacitor. The switching power supply device further includes a stabilizing circuit which is connected to the output terminal and consumes power at time of a light load of the LLC resonant converter.

### BRIEF DESCRIPTION OF THE DRAWINGS

FIG. 1 is a circuit diagram of a switching power supply device according to the present embodiment.

FIG. 2 is an equivalent circuit diagram of a configuration example of a stabilizing circuit.

FIG. 3 is a diagram for describing an operation of the stabilizing circuit shown in FIG. 2.

FIG. 4 is a voltage waveform diagram showing an example of an operation at the time of a light load of an LLC resonant converter.

FIG. 5 is a diagram showing normalized frequency characteristics of an LLC resonant circuit.

(A) and (B) of FIG. 6 are voltage waveform diagrams describing effects of the stabilizing circuit according to the present embodiment.

### DESCRIPTION OF THE EMBODIMENTS

Embodiments of this disclosure will be described in detail with reference to the drawings. Meanwhile, the same or corresponding parts in the figures are denoted by the same reference signs and description thereof will not be repeated.

### Application Example

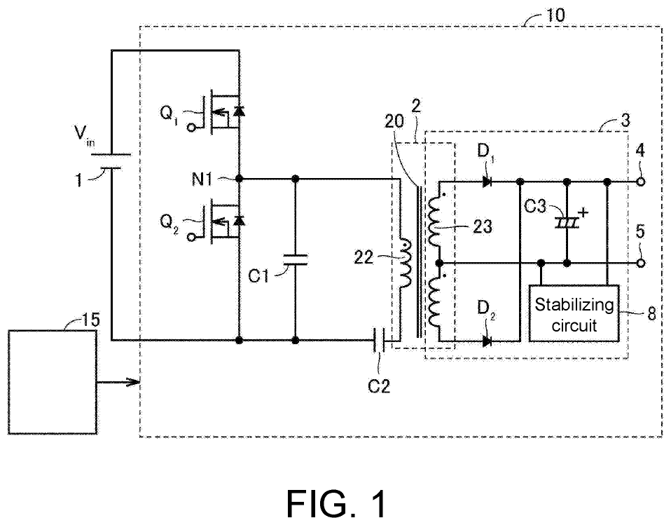

First, an example of a situation in which the disclosure is applied will be described using FIG. 1. FIG. 1 is a circuit diagram of a switching power supply device according to the present embodiment. As shown in FIG. 1, a switching power supply device 10 according to the present embodiment is a switching power supply device in which an LLC type is employed.

The switching power supply device 10 includes an LLC resonant converter. For example, the LLC resonant converter includes semiconductor switches Q₁ and Q₂ that are metal oxide semiconductor field effect transistors (MOSFETs), a transformer 2, capacitors C1 and C2, a secondary-side circuit 3, and output terminals 4 and 5.

The transformer 2 includes a core 20, a primary winding 22 and a secondary winding 23. The capacitors C1 and C2 are connected to the primary winding 22 of the transformer 2. Specifically, a first terminal of the primary winding 22 is connected to a first terminal of the capacitor C1. A second terminal of the primary winding 22 is connected to a first terminal of the capacitor C2. Further, a second terminal of the capacitor C1 and a second terminal of the capacitor C2 are connected to each other and connected to a negative electrode of a power supply 1. In this embodiment, the capacitor C2 corresponds to a “first capacitor.”

The transformer 2 may have a configuration in which a resonance inductor and a closely coupled transformer are combined. That is, a part of the primary winding may be used for a resonance inductor and the other part of the primary winding and the secondary winding 23 may constitute the closely coupled transformer. Alternatively, the transformer 2 may be a leakage flux transformer. In this case, a leakage inductance can be used for a resonance inductor. Accordingly, the resonant inductor and the closely coupled transformer can be integrated.

The semiconductor switches Q₁ and Q₂ constitute switching circuits that control power transmission to the transformer 2, the capacitor C2 (first capacitor) and the capacitor C1. Specifically, the semiconductor switches Q₁ and Q₂ constitute half bridge circuits serially connected between the positive electrode and the negative electrode of the power supply 1. A connecting point N1 of the semiconductor switches Q₁ and Q₂ is connected to the first terminal of the primary winding 22 of the transformer 2. The power supply 1 is a DC power supply that outputs a DC voltage Vᵢₙ. Turning of the semiconductor switches Q₁ and Q₂ on and off is controlled by a control signal from a control IC 15 (however, the disclosure is not limited to there being a control IC 15), for example.

The secondary-side circuit 3 includes the secondary winding 23 of the transformer 2, diodes D₁ and D₂, and a capacitor C3. The diodes D₁ and D₂ constitute a rectification circuit connected to the secondary winding 23 of the transformer 2. The capacitor C3 (second capacitor) is connected to the rectification circuit.

The switching power supply device 10 further includes a stabilizing circuit 8. The stabilizing circuit 8 is connected to the output terminals 4 and 5 of the LLC resonant converter. Specifically, the stabilizing circuit 8 consumes power at the time of a light load of the switching power supply device 10 (LLC resonant converter). In the case of the LLC type, a switching frequency increases at the time of a light load. When a switching element is operated at a high switching frequency, the switching frequency further increases at the time of a light load and thus a control IC may not be able to control the semiconductor switches. However, a light load of the switching power supply device 10 is compensated for since the stabilizing circuit 8 consumes power. Accordingly, a switching frequency increase can be suppressed to decrease a likelihood that the switching power supply device 10 (LLC resonant converter) will perform a burst operation.

<Configuration of Stabilizing Circuit>

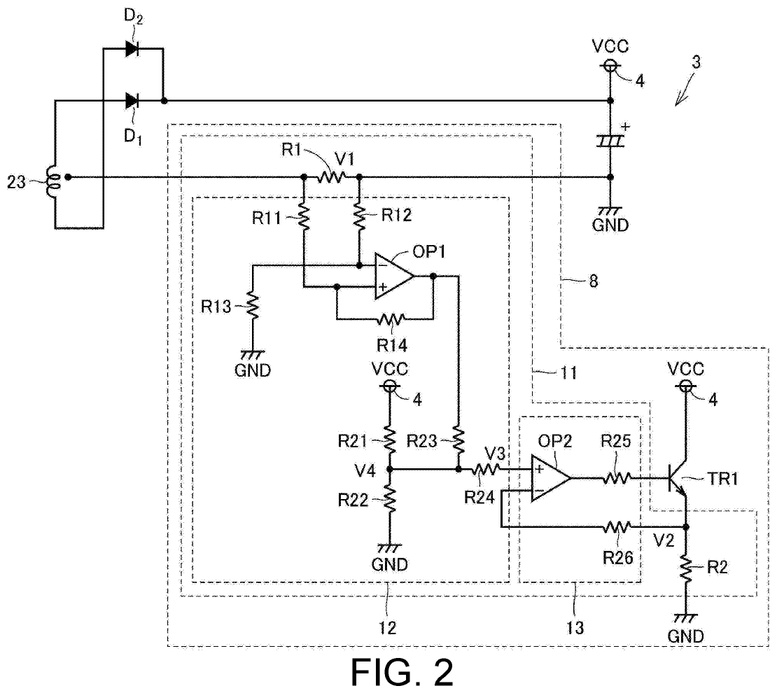

FIG. 2 is an equivalent circuit diagram of a configuration example of the stabilizing circuit 8. As shown in FIG. 2, the stabilizing circuit 8 includes a light load detection circuit 11 and a transistor TR1. The light load detection circuit 11 detects a light load state of the switching power supply device 10 (LLC resonant converter) on the basis of a current flowing through the secondary-side circuit 3 of the switching power supply device 10 (LLC resonant converter).

The transistor TR1 is electrically connected between the output terminal 4 of the LLC resonant converter and the ground and is turned on by the light load detection circuit 11. Based on the transistor TR1 is turned on, the stabilizing circuit 8 consumes power. Accordingly, the operation of the switching power supply device 10 at the time of a light load can be stabilized. Meanwhile, “VCC” represents a voltage generated at the output terminal 4 shown in FIG. 1.

The light load detection circuit 11 includes resistors R1 and R2, a voltage generation circuit 12, and a driving circuit 13. The resistor R1 is a resistor for converting the current flowing through the secondary-side circuit 3 into a first voltage (voltage V1). In other words, the resistor R1 is a resistor for detecting the current flowing through the secondary-side circuit 3. A first terminal of the resistor R1 is connected to a center tap of the secondary winding 23 of the transformer 2 (refer to FIG. 1). A second terminal of the resistor R1 is connected to the ground.

The resistor R2 is a resistor for converting a current flowing through the transistor TR1 into a second voltage (voltage V2). In other words, the resistor R2 is a resistor for measuring the current flowing through the transistor TR1. The resistor R2 is connected between the transistor TR1 and the ground. It is possible to detect whether the switching power supply device 10 is in a light load state on the basis of the current of the secondary-side circuit 3 and the current flowing through the transistor TR1 by using the resistors R1 and R2.

The voltage generation circuit 12 generates a third voltage (voltage V3) changing in a direction reverse to that of the first voltage (voltage V1). “Reverse direction” corresponds to a relationship in which, when one of the voltages V1 and V3 increases, the other voltage decreases. The voltage generation circuit 12 includes an operational amplifier OP1, resistors R11, R12, R13, R14, R21, R22, R23 and R24.

The resistor R11 connects the first terminal of the resistor R1 and the non-inverting input (positive side input) of the operational amplifier OP1. The resistor R12 connects the second terminal of the resistor R1 and the inverting input (negative side input) of the operational amplifier OP1. The resistor R13 connects the inverting input of the operational amplifier OP1 and the ground. The resistor R14 connects the output of the operational amplifier OP1 and the non-inverting input of the operational amplifier OP1. Accordingly, the operational amplifier OP1 amplifies the voltage V1.

The resistor R21 and the resistor R22 are connected in series between the output terminal 4 (voltage VCC) and the ground to form a resistance circuit. The connecting point of the resistor R21 and the resistor R22 corresponds to an output point of the resistance circuit. A voltage V4 proportional to the voltage VCC (voltage obtained by multiplying voltage VCC by a division ratio) is output from the output point of the resistance circuit.

The resistor R23 and the resistor R24 are connected in series to the output of the operational amplifier OP1. The connecting point of the resistor R23 and the resistor R24 is connected to the connecting point of the resistor R21 and the resistor R22. According to such a configuration, a constant current can flow through the transistor TR1 when the current flowing through the secondary-side circuit 3 decreases. Accordingly, the stabilizing circuit 8 can be operated in a light load state of the switching power supply device 10. On the other hand, when the current flowing through the secondary-side circuit 3 increases because the load of the switching power supply device 10 increases, the transistor TR1 is turned off. Accordingly, the stabilizing circuit 8 can be operated only in a light load state.

The driving circuit 13 includes an operational amplifier OP2 and resistors R25 and R26. The operational amplifier OP2 is an operational amplifier for turning the transistor TR1 on only in a light load state. The non-inverting input (positive side input) of the operational amplifier OP2 is connected to one terminal of the resistor R24. Accordingly, the voltage V3 is applied to the non-inverting input (positive side input) of the operational amplifier OP2. On the other hand, the inverting input (negative side input) of the operational amplifier OP2 is connected to the connecting point of the transistor TR1 and the resistor R2 through the resistor R26. Accordingly, the voltage V2 is applied to the inverting input (negative side input) of the operational amplifier OP2. The output of the operational amplifier OP2 is connected to a control electrode of the transistor TR1 through the resistor R25.

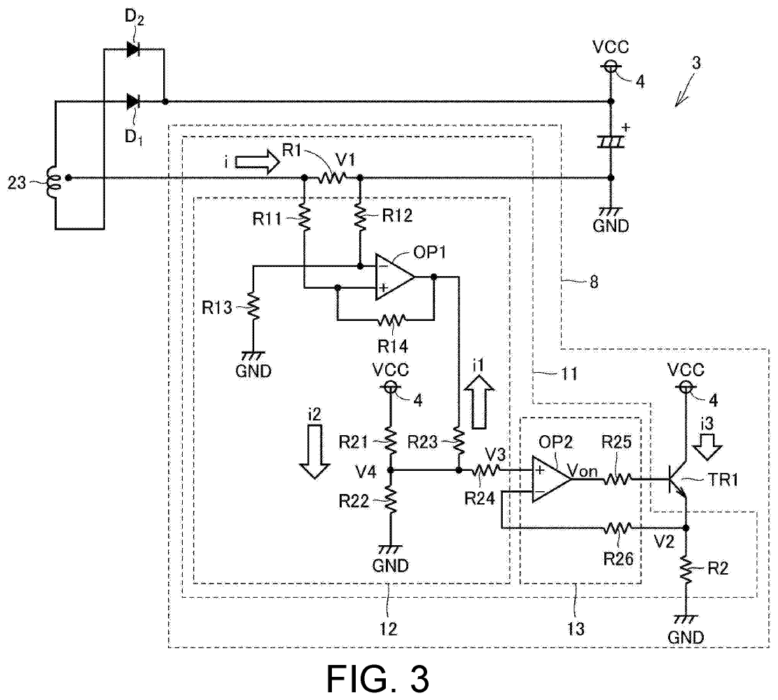

FIG. 3 is a diagram for describing the operation of the stabilizing circuit shown in FIG. 2. A current i flowing through the resistor R1 is small at the time of a light load of the switching power supply device 10. Accordingly, the voltage V1 is low. In this case, a negative voltage generated in the operational amplifier OP1 decreases. When a current i1 flowing through the resistor R23 to the output of the operational amplifier OP1 is compared with a current i2 flowing through the resistor R21 from the output terminal 4, i2>i1. Consequently, the input voltage (V3) of the positive side of the operational amplifier OP2 increases. That is, the voltage V3 increases when the voltage V1 decreases. Since the voltage V3 becomes higher than the input voltage (V2) of the negative side of the operational amplifier OP2, the output level of the operational amplifier OP2 becomes high. Accordingly, a voltage Von is output from the operational amplifier. OP2. When the voltage Von is applied to the control electrode of the transistor TR1, the transistor TR1 is turned on.

When the transistor TR1 is turned on, a current i3 having a constant magnitude flows through the transistor TR1 and the resistor R2. Accordingly, a power having a magnitude of Vcc×i3 is consumed by the resistor R2.

When the load (not shown in FIG. 3) of the switching power supply device 10 increases and thus the current (i.e., current i) flowing through the load increases to equal to or greater than the constant magnitude, the voltage V1 increases. Accordingly, the value of the current i1 increases. In this case, the voltage V3 decreases. That is, when the voltage V1 increases, the voltage V3 decreases. When i1>i2, the output level of the operational amplifier OP2 changes from a high level to a low level. When the output level of the operational amplifier OP2 becomes low, the transistor TR1 is turned off. Accordingly, consumption of power by the resistor R2 is stopped. In this manner, the stabilizing circuit 8 can consume power only in a light load state of the switching power supply device 10 (i.e., in a case in which the current i decreases to below a constant value).

<Operation of LLC Resonant Converter>

In the switching power supply device 10, a resonance circuit is formed of the inductance (or leakage inductance) of the resonance inductor of the primary winding and the capacitance of the capacitor C2. In the LLC resonant converter, an output voltage is controlled according to frequency changes using LC resonance. A resonance angular frequency ω₀ is determined by the inductance L_{SR} of the resonance inductor and the capacitance Cᵣ of the capacitor C2 as follows.

ω₀=1/(L_{SR}×Cᵣ)^{1/2}

In the above equation, a square root (√) is represented in the form of a power (½ power). A frequency f₀=ω₀/2π is about 100 kHz, for example.

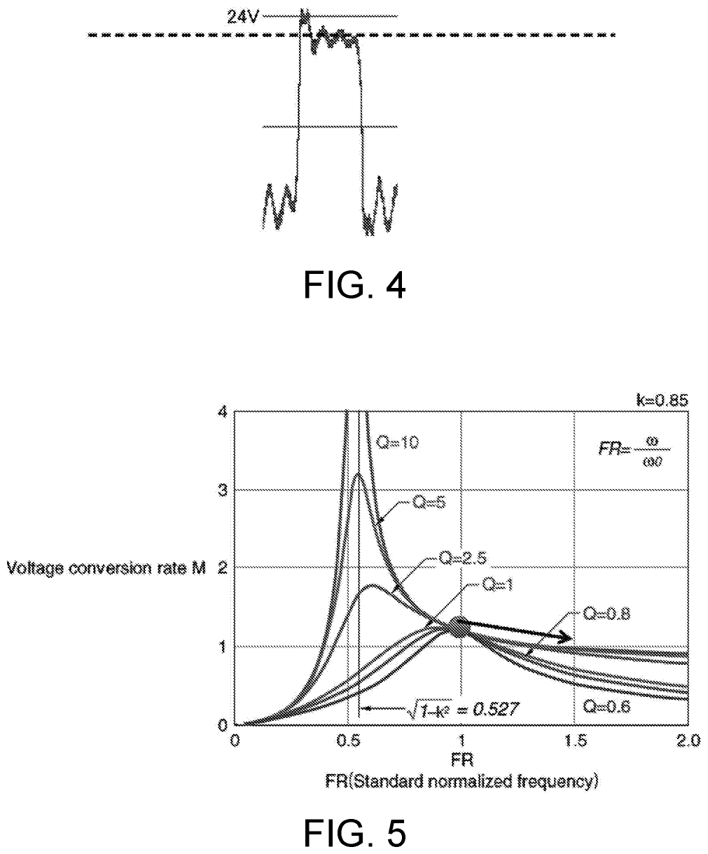

FIG. 4 is a voltage waveform diagram showing an example of an operation of the LLC resonant converter at the time of a light load. Further, FIG. 4 shows a voltage waveform of the secondary winding 23 of the transformer 2. For example, a normal output of the switching power supply device 10 is DC 24 V. Referring to FIG. 4, the output voltage 24V is kept according to a surge portion at the time of a light load. However, the substantial magnitude of the output voltage is the magnitude of the portion indicated by a broken line. The substantial output at the time of a light load is lower than the original output voltage (24V).

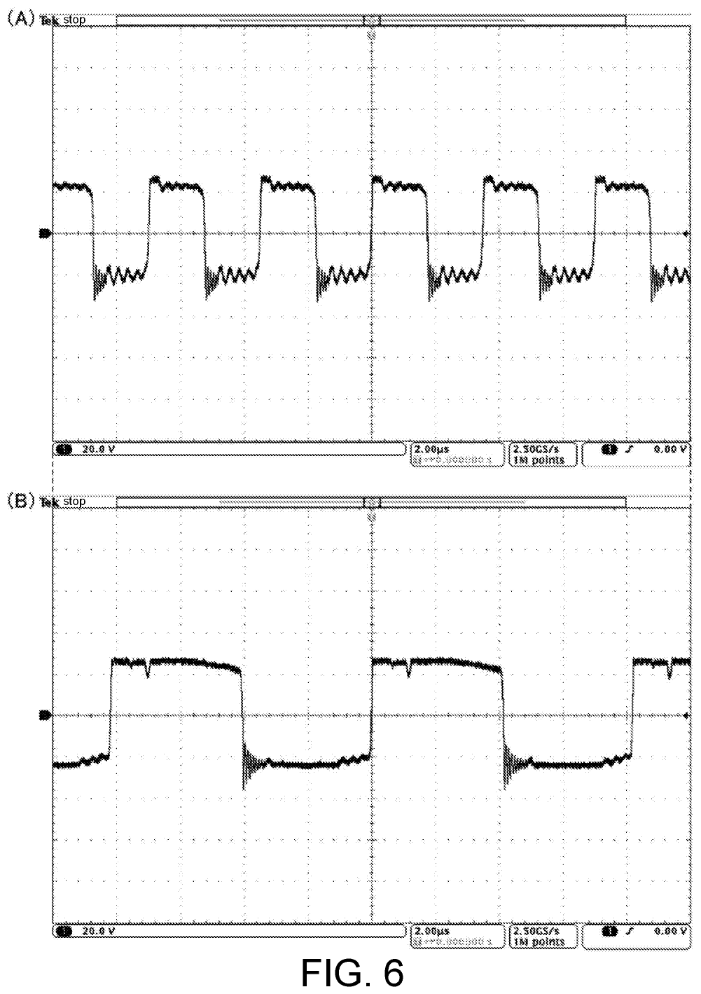

FIG. 5 is a diagram showing normalized frequency characteristics of an LLC resonance circuit. Referring to FIG. 5, the horizontal axis (FR) of the graph represents a frequency normalized with a resonance angular frequency ω₀. That is, a numerical value of the horizontal axis represents a ratio co/coo of a switching frequency co to the resonance angular frequency ω₀. The vertical axis of the graph represents a ratio of an output voltage to an input voltage. Further, k denoted in the graph represents a coupling constant of a transformer (for example, k=0.85).

The LLC resonance circuit operates having an operating point of FR=1 (ω=ω₀) as a center. Since Q increases due to a light load, a gain peak moves to a low frequency range. In this case, the switching frequency co increases because the output voltage decreases and the gain of the switching power supply device 10 decreases. When the switching frequency ω increases, the operating point moves to a range in which FR>1. When the switching frequency ω increases while the switching power supply device 10 is in a light load state, the switching power supply device 10 is likely to perform a burst operation.

<Operation and Effect of Stabilizing Circuit>

In the present embodiment, it is possible to cause a burst operation to hardly occur at the time of a light load state by providing the stabilizing circuit 8 at the output of the switching power supply device 10.

(A) and (B) of FIG. 6 are voltage waveform diagrams describing the effect of the stabilizing circuit 8 according to the present embodiment. (A) of FIG. 6 is a voltage waveform diagram when an LLC resonant converter operates in a light load state. (B) of FIG. 6 is a voltage waveform diagram when the stabilizing circuit 8 is added to the LLC resonant converter. The time scales of the horizontal axes are the same in (A) of FIG. 6 and (B) of FIG. 6.

As can be understood from comparison between (A) of FIG. 6 and (B) of FIG. 6, a switching frequency is high at the time of a light load. When a burst occurs, the LLC resonant converter enters an intermittent operation state, causing a noise at the time of a light load to increase or a response to load change to become slow. As shown in (B) of FIG. 6, the switching power supply device 10 according to the present embodiment operates the stabilizing circuit 8 at the time of a light load state. The stabilizing circuit 8 generates a load to consume power. Accordingly, an increase in the switching frequency ω is suppressed and thus transition of the switching power supply device 10 to a burst operation state is prevented.

In addition, according to the present embodiment, a ripple noise increase at the time of a light load can be suppressed since a burst does not occur. Further, a ripple noise frequency can be stabilized or dynamic load variation can be improved.

Moreover, when the stabilizing circuit 8 is configured to constantly consume power, the efficiency of the switching power supply device 10 deteriorates in a normal operation of the switching power supply device 10. In addition, the amount of heat generated from the switching power supply device 10 increases. In the present embodiment, the stabilizing circuit 8 consumes power only in a light load state. Accordingly, it is possible to prevent the efficiency of the switching power supply device 10 from deteriorating in a normal operation thereof and to suppress an increase in the amount of generated heat.

When the semiconductor switches Q₁ and Q₂ are selected in consideration of an increase in the switching frequency at the time of a light load, semiconductor switches for a high frequency must be selected as the semiconductor switches Q₁ and Q₂. However, a general LLC resonant converter has a switching frequency of about 100 kHz. When a semiconductor switch that can also operate at a higher switching frequency is selected, a narrow choice of the semiconductor switches Q₁ and Q₂ is provided. According to the present embodiment, it is possible to prevent the switching frequency of the semiconductor switches Q₁ and Q₂ from increasing because the stabilizing circuit 8 can prevent a burst operation. Accordingly, the range of choice of the semiconductor switches Q₁ and Q₂ can be widened. Therefore, a degree of freedom of design of the switching power supply device 10 can be increased.

<Supplementary Notes>

As described above, the present embodiment includes the following disclosure.

(Configuration 1)

A switching power supply device (10) includes an LLC resonant converter, wherein the LLC resonant converter includes: a transformer (2) having a primary winding (22) and a secondary winding (23); a first capacitor (C2) connected to the primary winding (22) of the transformer (2); a switching circuit (Q₁ and Q₂) which controls power transmission to the transformer (2) and the first capacitor (C2); a rectification circuit (D₁ and D₂) connected to the secondary winding (23) of the transformer (2); a second capacitor (C3) connected to the rectification circuit (D₁ and D₂); and an output terminal (4) connected to the rectification circuit (D₁ and D₂) and the second capacitor (C3), the switching power supply device (10) further including a stabilizing circuit (8) which is connected to the output terminal (4) and consumes power at time of a light load of the LLC resonant converter.

(Configuration 2)

In the switching power supply device (10) described in configuration 1, the stabilizing circuit (8) includes a light load detection circuit (11) which detects a light load state of the LLC resonant converter on the basis of a secondary-side current (i) flowing through a secondary-side circuit (3) of the LLC resonant converter including the secondary winding (23) of the transformer (2), the rectification circuit (D₁ and D₂) and the second capacitor (C3), and a transistor (TR1) electrically connected between the output terminal (4) of the LLC resonant converter and a ground and turned on by the light load detection circuit (11).

(Configuration 3)

In the switching power supply device (10) described in configuration 2, the light load detection circuit (11) includes a first resistor (R1) which converts the secondary-size current (i) into a first voltage (V1), a second resistor (R2) which converts a current flowing through the transistor (TR1) into a second voltage (V2), a voltage generation circuit (12) which generates a third voltage (V3) changing in a direction reverse to a direction in which the first voltage (V1) changes, and a driving circuit (13) which turns the transistor (TR1) on when the third voltage (V3) exceeds the second voltage (V2).

(Configuration 4)

In the switching power supply device (10) described in configuration 3, the voltage generation circuit (12) includes a resistance circuit including a plurality of resistors (R21 and R22) connected in series between the output terminal (4) of the LLC resonant converter and the ground, a first amplifier (OP1) which amplifies the first voltage, and a second amplifier (0P2) which has a first input connected to the output of the first amplifier (OP1) and the output of the resistance circuit (R21 and R22) to receive the third voltage (V3) and a second input for receiving the second voltage (V2), and outputs a voltage (Von) for driving the transistor.

According to the aforementioned configuration, it is possible to provide an LLC type switching power supply device in which it is difficult for a burst operation to occur at the time of a light load. The stabilizing circuit generates a load at the time of a light load to consume power. Accordingly, an increase in the switching frequency of the LLC resonant converter is suppressed. Therefore, it is possible to prevent transition of the switching power supply device to a burst operation state.

The stabilizing circuit may include a light load detection circuit which detects a light load state of the LLC resonant converter on the basis of a secondary-side current flowing through a secondary-side circuit of the LLC resonant converter including the secondary winding of the transformer, the rectification circuit and the second capacitor, and a transistor electrically connected between the output terminal of the LLC resonant converter and a ground and turned on by the light load detection circuit.

According to the aforementioned configuration, since the stabilizing circuit can be operated only in a light load state, it is possible to prevent the efficiency of the switching power supply device from deteriorating at the time of a normal operation of the switching power supply device.

The light load detection circuit may include a first resistor which converts the secondary-size current into a first voltage, a second resistor which converts a current flowing through the transistor into a second voltage, a voltage generation circuit which generates a third voltage changing in a direction reverse to a direction in which the first voltage changes, and a driving circuit which turns the transistor on when the third voltage exceeds the second voltage.

According to the aforementioned configuration, it is possible to detect whether the switching power supply device is in a light load state on the basis of the secondary-side current and current flowing through the transistor.

The voltage generation circuit may include a resistance circuit including a plurality of resistors connected in series between the output terminal of the LLC resonant converter and the ground, a first amplifier which amplifies the first voltage, and a second amplifier which has a first input connected to the output of the first amplifier and the output of the resistance circuit to receive the third voltage and a second input for receiving the second voltage, and outputs a voltage for driving the transistor.

According to the aforementioned configuration, when the secondary-side current decreases, a constant current can flow through the transistor. Accordingly, it is possible to operate the stabilizing circuit in a light load state of the switching power supply device. When the secondary-side current increases because the load of the switching power supply device increases, the transistor is turned off. Accordingly, it is possible to operate the stabilizing circuit only in a light load state.

According to the embodiments of the disclosure, it is possible to cause a burst operation to hardly occur at the time of a light load of an LLC type switching power supply device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A switching power supply device, comprising:
an LLC resonant converter,
wherein the LLC resonant converter includes:
a transformer having a primary winding and a secondary winding;
a first capacitor connected to the primary winding of the transformer;
a switching circuit which controls power transmission to the transformer and the first capacitor;
a rectification circuit connected to the secondary winding of the transformer;
a second capacitor connected to the rectification circuit; and
an output terminal connected to the rectification circuit and the second capacitor,
the switching power supply device further comprising a stabilizing circuit which is connected to the output terminal and consumes power at time of a light load of the LLC resonant converter,
wherein the stabilizing circuit includes:
a light load detection circuit which detects a light load state of the LLC resonant converter on the basis of a secondary-side current flowing through a secondary-side circuit of the LLC resonant converter including the secondary winding of the transformer, the rectification circuit and the second capacitor; and
a transistor electrically connected between the output terminal of the LLC resonant converter and a ground and turned on by the light load detection circuit.

2. (canceled)

3. The switching power supply device according to claim 1, wherein the light load detection circuit includes:
a first resistor which converts the secondary-size current into a first voltage;
a second resistor which converts a current flowing through the transistor into a second voltage;
a voltage generation circuit which generates a third voltage changing in a direction reverse to a direction which the first voltage changes; and
a driving circuit which turns the transistor on when the third voltage exceeds the second voltage.

4. The switching power supply device according to claim 3, wherein the voltage generation circuit includes:
a resistance circuit including a plurality of resistors connected in series between the output terminal of the LLC resonant converter and the ground;
a first amplifier which amplifies the first voltage; and
a second amplifier which has a first input connected to the output of the first amplifier and the output of the resistance circuit to receive the third voltage and a second input for receiving the second voltage, and outputs a voltage for driving the transistor.
